(19) United States
(12) Patent Application Publication
(10) Pub. No.: US 2002/0046154 A1
(43) Pub. Date: Apr. 18, 2002

(54) Systems and methods for developing and administering investment trusts

(76) Inventor: Andrew H. Pritchard, Norwalk, CT (US)

Correspondence Address: FISH & NEAVE, 1251 AVENUE OF THE AMERICAS, 50TH FLOOR, NEW YORK, NY, 10020-1105, US

(21) Appl. No.: 09/927,628

(22) Filed: Aug. 10, 2001

Related U.S. Application Data
(60) Provisional application No. 60/228,142, filed on Aug. 25, 2000.

(51) Int. Cl. G06F 17/60

(52) U.S. Cl. 705/37; 705/36

(57) ABSTRACT

Financial management systems and methods for development and administration of investment trusts which may be traded as a securities are provided. These trusts may be based on underlying investment instruments optimally selected to provide dividends and equity, and the trusts value may reflect accrued investment income and maintenance expenses. The financial management systems and methods may receive input from the relevant markets of the underlying investment instrument products and dividend investments, and periodically evaluate and report the performance of the investment trust. The financial management systems and methods may also permit investors in the trusts to redeem their ownership in the trust for cash or investment instruments of the trust.

### CROSS REFERRENCE TO RELATED APPLICATION

This application claims the benefit of U.S. provisional patent application Ser. No. 60/228,142, filed Aug. 25, 2000, entitled INVESTMENT TRUST by Andrew H. Pritchard, which is hereby incorporated by reference herein in its entirety.

### BACKGROUND OF THE INVENTION

The present invention relates to systems and methods for developing and administering financial instruments. More specifically, the present invention relates to systems and methods which facilitate the development, administration, and tracking of investment trusts that may be traded on an exchange.

Among the various investment options available, mutual funds, which offer a variety of investment options and which may be selected to meet specific customer needs, have recently become popular. Different funds have been designed to invest in particular types of stocks, to invest in specific industry sectors, and to track the performance of market indicators.

Compared to direct investments in equity stocks, mutual funds are frequently attractive to investors because they provide investors with the opportunity to participate in capital markets for a relatively low fee. A portion of such fees may be used to finance research directed to selecting a specific investment portfolio for each fund. The performance of a given professionally managed mutual fund may be determined by the total investment in the fund.

Professionally managed mutual funds, however, have received criticism. Some funds have been outperformed by general equity market indicators, such as the Standard & Poor's 500 (S&P 500) index, which is a relative valuation of the stocks of 500 large companies.

The unsatisfactory performance of many managed funds has created substantial interest in unmanaged investment products that track the overall performance of the equity markets. Such products may include indexed stock funds that invest in the stocks of the S&P 500 companies. These products directly track the performance of the S&P 500 index and typically are unencumbered by high asset research fees and transaction costs. Other investment products have also been offered to track the performance of select foreign markets.

Recently, new types of investment products have been proposed. One approach is represented by the Toronto Index Participation Units (“TIPS”). TIPS is an open end unit trust structure which was designed to follow the Toronto 35 Index.

Another relatively recent product is the Standard & Poor's Depositary Receipts™ (“SPDRs”). These securities, which are traded on the American Stock Exchange (AMEX), are financial instruments devised to package equity in multiple companies into a single listed security. SPDRs represent ownership in a SPDR Trust, a unit investment trust, which holds a portfolio of common stocks that tracks the price performance and dividend yield of the S&P 500 Index. Much like open end unit trusts (such as TIPS), SPDRs are rebalanced daily and may trade at a premium or discount to the corresponding index. SPDRs may also be held like a stock for a long time and entitle the holder to quarterly cash distributions corresponding to the dividends that accrue to the S&P stocks in the underlying portfolio. While SPDRs provide desirable diversification and convenience, they are only offered in a limited number of capital markets.

Because of inherent restrictions in their design, the above-described investment products may not provide the desired diversity, level of service, and risk/return ratio selections that some investors may prefer.

Accordingly, it is desirable to provide a financial management system for developing and administering investment trusts with a variety of underlying securities products and dividend-producing investments that may be traded on an exchange. Furthermore, it is desirable to have a financial management system offering a full range of services including administering, monitoring and reporting on the return of the investment trusts that provide investors with versatile options to participate in different markets.

### SUMMARY OF THE INVENTION

In accordance with the present invention, systems and methods for implementing, coordinating, supervising, analyzing and reporting upon investment trusts which may be traded as securities are provided. These investment trusts may be based on underlying investment instruments optimally selected to provide dividends and equity, and the prices for these trusts may reflect accrued investment income, dividend return, equity, and maintenance expenses. The systems and methods may receive input from the relevant markets of the underlying investment instruments and periodically evaluate the performance of an investment trust and its underlying investment instruments to investors and brokers. The present invention may also relate to a financial data processing system for administering an investment group of such investment trusts.

The investment instruments underlying the investment trust of the present invention may be selected by a financial system which may use economic and financial variables, risk allocation factors and data about individual investment instruments in the market to make forecasts. The financial system may then suggest investment instruments which may be optimally selected for an individual investor to achieve growth in equity and produce a yield over a period of time. Investment trusts may also be selected by the financial management system to form an investment trust of trusts.

The financial management system of the present invention may package the optimally selected investment instruments into an investment trust to be traded on an exchange. The trust may be redeemable to investors at specific times or at any time for cash or for instruments in the trust at the value of the individual investment instruments, at the value of the trust, or at a settled value. Proceeds from the redemption may be rolled over into a new trust.

During the life period of an investment trust, the financial data processing system may provide continuous monitoring of the value of the trust and/or the underlying investment instruments. The system may combine current value information with historical data representing financial characteristics of each investment instrument in the trust to generate the current value of each instrument, or the entire trust, at any time. The financial data processing system may use financial characteristics to estimate information about trade transactions or values of investment instruments and thus may provide an accurate estimate of the values of the investment instruments or the value of the trust.

Based on the information on each investment instrument, the financial data processing system may compute the current aggregate value of the investment trust. This aggregate value may be further modified to reflect clearing, custody and other management costs and income accrued from the investment instruments to generate a composite price for the trust which is the listed price at which the trusts may be traded. Because the investment trusts may be traded as single securities, investors may gain exposure to many different markets with a single trust security.

An investor who may be willing to sell the investment trust may send instructions to do so to an operator of the financial management system. The value of the trust may be redeemed by receiving underlying instruments in the trust, or by receiving cash upon selling the underlying individual investment instruments, the trust itself, or by reaching a settlement value.

The financial management system may provide a real-time update of all the instruments which comprise the investment trust, and may supervise, analyze and periodically report on the investment activities associated with the trust.

In one aspect of the invention, the financial data processing system may monitor the performance of the underlying investment instruments of the trust, as well as the trust itself, in order to generate reports to investors and/or brokers on the value of the trust and its underlying investment instruments, on the present and expected return of the investment and other information. Such reports, which may have different levels of detail, may be valuable to investors and/or brokers who follow the value of their investment and may wish to optimize or alter their investment strategy.

In another aspect of the invention, a system and a method for optimized selection of investment instruments underlying an investment trust may be provided. The performance of the system and the method may be designed to track the performance of the investment instruments over a limited period of time.

In a further aspect of the invention, a financial data processing system for administering information on each investment instrument in a selected investment trust may be provided.

In an additional aspect of the invention, a financial data processing system may be provided for determining a value for an investment trust so as to reflect the current aggregate value of the investment instruments and accrued income and expenses associated with all instruments in the trust.

In another aspect of the invention, the investment trust may guarantee a fixed yield or variable rate of return.

In an additional aspect of the invention, the investment trust may be redeemable at any time for cash or the underlying elements of the trust, at the value of the elements or the trust itself, or at some settlement value.

In a further aspect of the invention, the investment trust may comprise only a single element, and may represent a specific value at the time of purchase. The value of the trust may track in realtime the value of the underlying element of the trust.

In one aspect of the invention, the investment trust may combine equity elements with fixed or variable return elements. In this aspect of the invention, the investor may have the opportunity to own a high growth stock, which pays a small dividend or no dividend at all, while obtaining a certain minimum yield per time period. The investment trust may track the value of the underlying elements, or may establish a new value in trading the combined elements. The trust may be redeemable for the elements or some settlement value at anytime or from time to time. The elements may be disassembled, may each be traded individually in their respective markets, may be kept together and traded as is, or may be settled for some value.

In another aspect of the invention, the investment trust may combine equity investments, U.S. Treasury securities and bonds, trusts, alternative dividend-producing investments, or other suitable investments. The overall combination of investments may generate a yield. Investment devices that comprise the trust may be selected so as to tailor an individual investor's risk and return requirements.

In an additional aspect of the invention, the investment trust may be constructed within an electronic marketplace to facilitate trading under any number of rules based on time, quantity, amount or any combination thereof.

In a further aspect of the invention, matching and searching systems and methods may be used locate instruments which will generate a specific fixed return.

In one aspect of the invention, matching and searching systems and methods may search across markets for elements to construct the investment trust.

In another aspect of the invention, a financial management system may contain data for prior growth or loss on a variety of investment instruments that may be used in the creation of an investment trust.

In an additional aspect of the invention, the financial management system may construct the trust by selecting investment elements, provide for trading of the trust, provide tracking services to ascertain the value of the trust itself or value based on the underlying elements of the trust, and provide for the disassembly of the trust for value if it is necessary or desired.

In a further aspect of the invention, the financial management system may automatically redeem the value of the investment trust upon the occurrence of any event relating to the participants of the trust, the yield of the trust, or the overall price of the value of the elements in the trust, or any other suitable event.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is a schematic of a financial data processing system in accordance with certain embodiments of the present invention;

FIG. 2 illustrates a flow diagram for the development and administration of investment trusts in accordance with certain embodiments of the present invention; and

FIG. 3 illustrates a flow diagram for buying, selling, and tracking investment instruments in accordance with certain embodiments of the present invention.

### DETAILED DESCRIPTION OF THE INVENTION

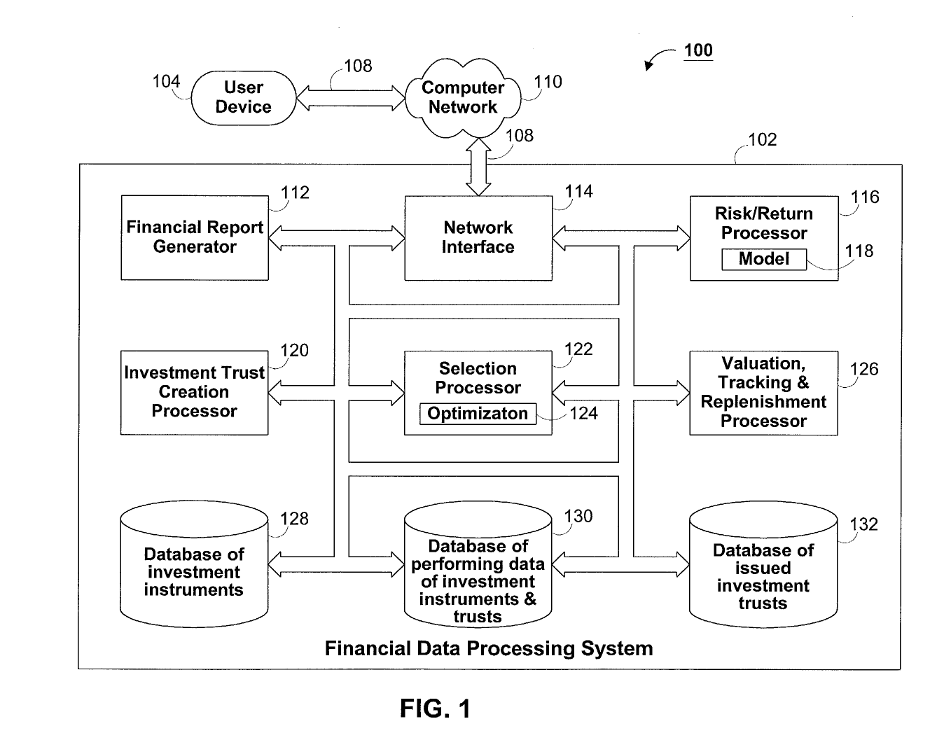

The present invention is now described in more detail in conjunction with FIGS. 1-3.

FIG. 1 illustrates a schematic of a financial data processing system in accordance with certain aspects of the present invention. As shown, system 100 may include financial data processing system 102, user device 104, communications links 108, and computer network 110.

A user using user device 104 may be a broker or an investor. User device 104 may be a personal computer, laptop computer, handheld computer, telephone, cellular telephone, or any other suitable device capable of performing the functions described herein.

Communications link 108 may be copper wire, twisted pair, telephone line, coaxial cable, fiberoptic cable, satellite, radio transmission, microwave transmission, light wave transmission, electromagnetic transmission, a cable modem connection, a digital subscriber line (DSL), a dial-up connection, or any other suitable connection, or combination of the same.

Computer network 110 may be any securities exchange, financial exchange, Internet, Intranet, Local Area Network (LAN), Metropolitan Area Network (MAN), Wide Area Network (WAN), Virtual Private Network (VPN), wireless network or any other suitable computer network, or combination of the same.

Financial data processing system 102 may include the following subsystems: financial report generator 112; network interface 114, risk/return processor 116 with risk/return model 118; investment trust creation processor 120; selection processor 122 with selection optimization 124; valuation, tracking and replenishment processor 126; database of investment instruments 128; database of performance data of investment instruments and trusts 130; and database of issued investment trusts 132. Network interface 114 may be a modem, Ethernet card, cable modem, DSL modem, network card, USB interface, serial interface, parallel interface, infrared interface, radio frequency interface, microwave frequency interface, optical interface, electromagnetic interface, or any other suitable interface. The remaining subsystems may be implemented using any suitable hardware (e.g., a computer), software (e.g., processing or database programs), or combination of the same, and may be located in a single facility or may be distributed.

Financial report generator 112 may produce a financial report. User device 104 may be used to input a request to receive a financial report from financial data processing system 102 on valuations of investment trusts or the underlying investment instruments of the investment trusts. Upon receipt of the request by financial data processing system 102, financial report generator 112 may gather financial information from database of performance data of investment instruments and trusts 130. Database 130 may require valuation processor 126 to acquire current valuation data as available on computer network 110. Upon collection of all relevant financial data, financial report generator 112 may transmit a financial report to user device 104 over communications link 108 that may be viewed by a user.

Risk/return processor 116 may contain a risk/return model 118 to assist in evaluating the risk and return of a given selection of investment instruments that may be used to form an investment trust.

Investment trust creation processor 120 may be utilized to form an investment trust that may be capable of being traded on an exchange, as well as redeemed at a particular time or any time, from selected investment instruments. Investment instruments may be any stock, bond, security, debt instrument, exchange traded fund (ETF), mutual fund, currency, commodity, equity investment, futures investment, dividend-paying investment, investment trust or any other suitable asset or investment.

Selection processor 122 may be utilized to select investment instruments to become the basis of an investment trust, based upon the risk/return preferences indicated by a user. Selection optimization processor 124 may be used to optimize the selection of the investment instruments so as to best meet the risk/return preferences of a user. Selection processor 122 and/or selection optimization processor 124 may utilize the database of investment instruments 128 and/or the database of performance data 130 in order to aid in the selection and/or optimization of selection of suitable investment instruments to meet the risk/return requirements of a user.

Valuation, tracking, and replenishment processor 126 may have a variety of functions. Processor 126 may perform valuation analysis on investment instruments or investment trusts by using data from database of performance data 130 or from computer network 110. Processor 126 may track the value of investment instruments and/or investment trusts in real-time or periodically over time. Valuation information, once acquired by processor 126, may be transmitted to database of performance data 130.

Processor 126 may also assess whether an investment instrument, which may or may not be part of a investment trust, may be about to expire. If processor 126 determines that an investment instrument may be about to expire, processor 126 may replenish the investment trust with a similar investment instrument. Processor 126 may purchase the investment instrument on the relevant market. Selection processor 122, optimization processor 126, and/or risk/return processor 116 may be used in the replenishment and/or purchasing process. After the purchase or replenishment of an investment instrument, processor 126 may update database of investment instruments 128 and/or database of issued investment trusts 132.

Database of investment instruments 128 may contain records of all available investment instruments that may be selected from in the creation of an investment trust and which may or may not have been already purchased on the relevant market. Investment instruments may be any stock, bond, security, debt instrument, exchange traded fund (ETF), mutual fund, currency, commodity, equity investment, futures investment, dividend-paying investment, investment trust or any other suitable asset or investment.

Database of performance data of investment instruments and investment trusts 130 may contain records of past and current financial return performance over a period of time of all investment instruments that may or may not be a part of a past or current investment trust, and/or that may or may not have been purchased in the relevant market.

Database of issued investment trusts 132 may contain records of investment trusts that may be traded on an exchange presently or may have been traded on an exchange in the past. Database 132 may also contain records of the underlying investment instruments of the currently traded investment trusts and/or investment trusts that have been traded in the past.

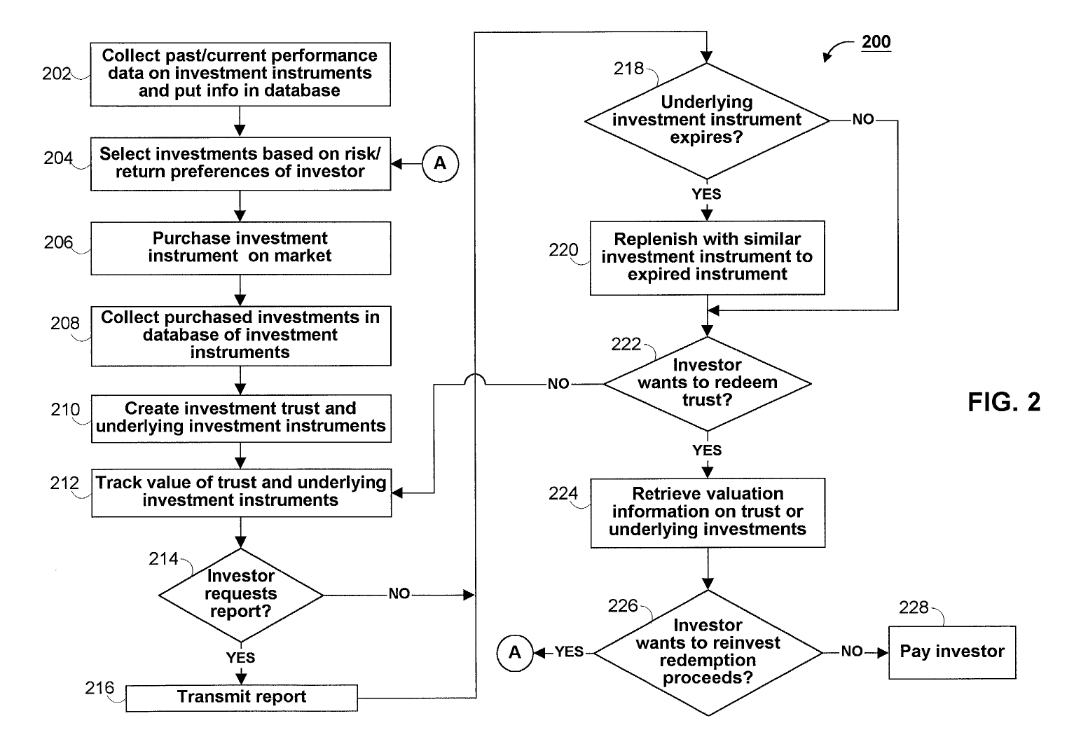

FIG. 2 illustrates a flow diagram of a process 200 for the development and administration of investment trusts in accordance with certain aspects of the present invention.

As shown, once process 200 has begun, at step 202, current financial return performance data and/or past performance data may be collected on investment instruments and stored in a database. An investment instrument may be any stock, bond, security, debt instrument, exchange traded fund (ETF), mutual fund, currency, commodity, equity investment, futures investment, dividend-paying investment, investment trust or any other suitable asset or investment.

Selection of investment instruments may occur next at step 204. The selection may be based in whole or in part upon the risk/return preferences of an investor and/or a broker. The selection of investment instruments may be optimized to achieve a desired level of risk and return.

Next, selected investment instruments may be purchased at step 206. The instruments may be automatically purchased using a purchasing algorithm and electronic trading, or a trader could be instructed to place the corresponding trades. At step 208, the purchased investment instruments may be collected, and the record of the purchase and the attributes of each investment may be placed in a database.

Next, at step 210, an investment trust may be created which may be composed of the selected investment instruments. Upon creation of the investment trust, it may be traded on an exchange, or redeemed at a select time or any time for the value of the trust as a whole, the value of the underlying investment instruments, or for some other settled value.

The value of the investment trust and/or the value of the underlying investment instruments that make up the trust may be tracked at step 212. Valuation and tracking of investment trusts or investment instruments may be performed periodically or in real-time. Valuation data that may be obtained from the tracking process may be stored and/or updated in a database.

Next, at step 214, an investor or a broker may request a financial report. If a financial report is not requested, the process may branch to step 218. If a report is requested, a report may be compiled at step 216 from current and/or past valuation information, and then may be presented to an investor or broker.

At step 218, a determination may be made as to whether an investment instrument is about to expire. An investment trust may be composed of investment instruments that may expire. A bond, for example, may have a limited lifetime associated with it, and will expire at the end of that lifetime. If the investment instrument is not about to expire, process 200 may branch to step 222.

On the other hand, if the investment instrument is about to expire, process 200, at step 220, may allow for the substitution of the expired instrument with an investment instrument with a similar risk/return ratio so that the investment trust may continue to be traded and/or valued as a security. A database of investment instruments may be updated with new information about the instrument which may be substituted. A database of issued investment trusts may be updated to reflect a change in investment instruments because of the replenishment process.

At step 222, an investor may want to redeem an investment trust. If an investor does not want to redeem the trust, process 200 may loop back to step 212 to continue tracking the trust and/or the investment instruments that make up the trust. If the investor wants to redeem the trust, a retrieval of valuation information on the trust or the underlying investment instruments of the trust may be performed at step 224. Valuation information may be retrieved from a database, securities exchange, or servers on a computer network.

Next, at step 226, a determination may be made as to whether an investor would like to reinvest the redemption proceeds. If the investor does not wish to reinvest, the investor may be paid with cash or investment instruments from the trust at the value of the trust, the value of the underlying investment instruments, or some other settlement value at step 228. If the investor would like to reinvest the redemption proceeds, process 200 may branch to step 204 to select new investment instruments based in whole or in part on the risk/return preference of the investor. The proceeds that the investor may reinvest may be the value of the redeemed trust, the value of the underlying investment instruments of the redeemed trust, or any settlement value for the redeemed trust.

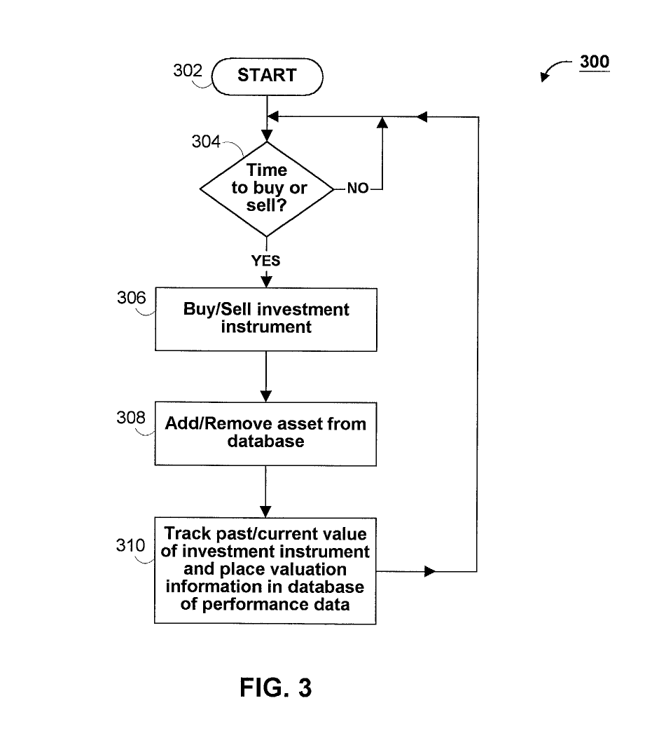

FIG. 3 illustrates a flow diagram of a process 300 for buying, selling, and tracking investment instruments in accordance with one aspect of the present invention. Process 300 begins at step 302, and then proceeds to step 304, where a determination may be made as to whether it is time to buy or sell an investment trust or investment instrument. In the instance that it may not be time to buy or sell, step 304 is repeated. If it is determined that it may be time to buy or sell, the investment trust or investment instrument may be bought or sold at step 306. A broker or investor may make the determination as whether to buy or sell. The determination as to whether to buy or sell may also be automatically triggered on the basis of the dynamics of the relevant market in which the investment trust or investment instrument may be traded or valued.

Next, at step 308, the investment trust or investment instrument may be added to or removed from the database containing the record of the trust or investment instrument. Valuation reports or financial return performance data may be retained in a database to be used for future reference.

At step 310, the current and/or past value of the investment trust and/or the underlying investment instrument may be tracked. Data from the tracking process of step 310 may be added to a database for future reference. Next, the process may return to step 304, where a determination is made as to whether it may be an appropriate time to buy or sell.

In a preferred embodiment of a trust in accordance with the present invention, the trust may contain at least a combination of an equity element, i.e. a common stock, combined with a fixed or variable return element, such as sets of coupon strips from a 30 year U.S. Treasury bond. Such a trust may provide an investor with the opportunity to own a high growth stock, which may not pay a dividend or a sufficient dividend, while obtaining a sufficient yield per time period. Such a trust preferably trades like stock having a value that tracks the value of the underlying investment instruments, or it may establish a new value in trading the combined elements.

In another preferred embodiment of a trust in accordance with the invention, the trust may contain multiple types of elements, e.g. the strips of coupons from 30 year US Treasury Bonds, combination of two year treasury securities, common stock in a technology company, and copyright revenue generation potential from a catalog of songs for some period of time. Such a trust may similarly contain an equity, an intellectual property right such a right to receive royalties on a copyright or a patent, and the strip of coupons from 30 year Treasury Bonds. Such a mix may generate a minimum yield, i.e. interest income, potential income or realized gain. Other investments could also be used such as leases on real property, art, collectibles, futures contracts on revenues of a business, etc.

A trust in accordance with the invention may be redeemable for the investment instruments of the trust or some settlement value at anytime or from time to time. The investment instruments of the trust may also be disassembled and each traded individually in their respective markets, kept together and traded as is, or settled for some value. Such a trust may enhance the ability of fund portfolio managers to meet seemingly contradictory return requirements of a particular fund. For example, certain fund managers may be required to guarantee a minimum rate of return that could be achieved through the purchase of government bonds while those managers also desire to purchase high-growth, high-risk equities.

As can be seen, financial management systems and methods for development and administration of investment trusts are provided. It will be understood that the foregoing is merely illustrative of the principles of the invention and the various modifications can be made by those skilled in the art without departing from the scope and spirit of the invention, which is limited only by the claims that follow.

What is claimed is:

1. A method for developing and administering investment trusts comprising:
selecting an investment instrument from a plurality of available investment instruments;
creating an investment trust with the selected investment instrument;
trading the investment trust on a financial exchange to provide an ownership interest in the investment trust; and
redeeming the ownership interest in the investment trust for at least the investment instrument.

2. The method of claim 1, further comprising creating a database of investment instruments available for selection.

3. The method of claim 1, further comprising optimizing which investment instruments are selected to produce a desired growth in equity and yield return at a selected level of risk.

4. The method of claim 1, further comprising tracking the value of the investment instrument.

5. The method of claim 4, further comprising storing value information related to the tracked investment instrument in a database.

6. The method of claim 1, further comprising generating a financial report.

7. The method of claim 1, further comprising:
determining whether the investment instrument expires; and
replacing the investment instrument with a similar investment instrument when the investment instrument expires.

8. The method of claim 1, further comprising creating a database of investment trusts.

9. A system for developing and administering investment trusts comprising:
a means for receiving a selection of an investment instrument from a plurality of available investment instruments;
a means for creating an investment trust with the received selection of the investment instrument;
a means for trading the investment trust on a financial exchange to provide an ownership interest in the investment trust; and
a means for redeeming the ownership interest in the investment trust for at least the investment instrument.

10. The system of claim 9, further comprising a means of creating a database of investment instruments available for selection.

11. The system of claim 9, further comprising a means of optimizing which investment instruments are selected to produce a desired growth in equity and yield return at a selected level of risk.

12. The system of claim 9, further comprising a means of tracking the value of the investment instrument.

13. The system of claim 12, further comprising a means of storing the value information of the tracked investment instrument in a database.

14. The system of claim 9, further comprising a means for generating a financial report.

15. The system of claim 9, further comprising:
a means for determining whether an investment instrument expires; and
a means for replacing the investment instrument with a similar investment instrument when the investment instrument expires.

16. The system of claim 9, further comprising a means of creating a database of investment trusts.
